(19) United States
(12) Patent Application Publication
(10) Pub. No.: US 2012/0060961 A1
(43) Pub. Date: Mar. 15, 2012

(54) Tubes for High Temperature Industrial Application and Methods for Producing Same

(76) Inventors: Milo Van Landingham Kral, Christchurch (NZ); Cheruvari Karthik Hari Dharan, Berkeley, CA (US)

(21) Appl. No.: 13/254,177

(22) PCT Filed: Mar. 3, 2010
(86) PCT No.: PCT/NZ2010/000038

§ 371 Date: Nov. 18, 2011

Related U.S. Application Data
(60) Provisional application No. 61/157,011, filed on Mar. 3, 2009.

(51) Int. Cl. F16L 9/14; B32B 37/14; B32B 37/02

(52) U.S. Cl. 138/153; 156/185

(57) ABSTRACT

A high temperature industrial plant metal alloy tube for use in high temperature industrial plant such as a reformer tube having lower creep comprises around the tube one or more layers of reinforcement material for example wire or mesh of a refractory material. A method of producing the tube and plant comprising the tube are also claimed.

### FIELD

The invention relates generally to a tube construction for high temperature industrial application such as for example in reformer tubes.

### BACKGROUND

Pipework in industrial plant which operates at high temperature and is also subjected to stress will experience a progressive damage mechanism known as creep. For example in vertical runs of pipework or tubes (hereinafter referred to as tube(s)) creep can occur downwardly i.e., in-axis due to gravity. This may occur in plant carrying out direct reduction of iron ore (DRI plant) for example. Creep may also occur across the tube axis where the tubes are subjected to internal pressure as well as high temperature, such as in reformer plant such as in catalytic or steam reforming.

By creep is meant slow migration of material of the tube Wall so that after a period of operation of the plant, a tube (or tubes) of for example, constant wall thickness over its length at the beginning of its life, at the end of its life will have exceeded allowable dimensions or even rupture, thus requiting replacement.

### SUMMARY OF THE INVENTION

In a first aspect, the invention broadly comprises a metal alloy tube forming part of or for use in high temperature industrial plant, comprising around the tube a layer of reinforcement material of lower creep at temperatures above about 40% of the absolute melting point of the metal alloy tube.

In one embodiment the reinforcement material comprises a refractory material such as tungsten, molybdenum, niobium, tantalum, columbium, hafnium, boron, or rhenium, or metal oxides such as alumina (Al₂O₃), or carbides such as tungsten carbide (WC) in filamentary form which may, for example, be in wire form wound around the outside of the metal alloy tube. Alternatively, the reinforcement material may be in mesh or woven form or other sheet form.

Where the reinforcement material comprises a filamentary reinforcement around the tube, the filament(s) may be wound around the tube transverse to the axis of the tube or at an angle to the axis of the tube, particularly where the tube will be subject to internal pressure as well as high temperature, or will be horizontally mounted or mounted at an angle to the horizontal or vertical even in low pressure applications. Alternatively again, the reinforcement may comprise filaments on the outside of the tube which extend along the axis of the tube.

In some embodiments the tube may comprise a second reinforcement layer such as a second wire layer wound around the tube over the first layer and preferably at an angle to the first layer. Where the reinforcement material is in mesh or woven form the tube may comprise a second mesh or woven layer, which may be applied to the tube so that the warp and weft of the second layer extend at an angle to the warp and weft of a first mesh or woven reinforcement layer.

In a second aspect, the invention broadly consists in a method of manufacture of a metal alloy tube for use in high temperature industrial plant, comprising forming the tube with a layer of a reinforcement material around the tube, the reinforcement layer having lower creep at temperatures above about 40% of the absolute melting point of the metal alloy tube.

In one embodiment, the manufacturing method comprises forming a layer of a reinforcement material into a tubular form or pre-forms of various geometry and subsequently centrifugally casting a metal alloy tube within and to the tubular reinforcement material.

In another embodiment the manufacturing method comprises casting or extruding a metal alloy tube and applying a layer of a reinforcement material around the tube. Plasma or thermal spraying of a metal alloy or various different alloys) around the layer(s) of reinforcement may be applied to further consolidate the reinforcement and to provide additional properties, such as functional graded properties, to the final tube assembly.

By ‘high temperature’ in this specification is meant typically temperatures above 500° C. and typically in the range of 750-1500° C.

By ‘refractory material(s)’ is meant materials which will retain their strength at temperatures above 1000F (538C).

The term “comprising” as used in this specification means “consisting at least in part of”. When interpreting each statement in this specification that includes the term “comprising”, features other than that or those prefaced by the term may also be present. Related terms such as “comprise” and “comprises” are to be interpreted in the same manner.

### BRIEF DESCRIPTION OF THE DRAWINGS

The invention is further described with reference to the drawings and by way of example only, in which:

FIG. 1 shows one embodiment of a high temperature industrial plant tube of the invention,

FIG. 2 shows another embodiment of a high temperature industrial plant tube.

### DETAILED DESCRIPTION OF EMBODIMENTS

Referring to the drawings a metal alloy tube 1 is formed of a corrosion resistant alloy such as for example, an alloy comprising in the range 23-26% by weight chromium, 32-36% by weight nickel, and 0.35-0.4% by weight carbon, and the alloy may also comprise about 1.5% by weight manganese and about 1.5% by weight silicon. The alloy may also optionally comprise other ‘micro-alloying’ additions. The balance of the alloy comprises iron. In one particular embodiment metal alloy tube 1 is formed of a corrosion resistant alloy comprising approximately 25% chromium, 35% nickel, 0.4% carbon, and 39.6% iron. Typically, the unreinforced metal alloy is suitable for use at temperatures above 500° C. and typically at temperatures in the range of 750-1100° C. and the tube may be suited for use with internal pressures of 45 bars, for example. The tube may be a reformer tube for a catalytic reformer, for example, which contains a catalyst which is contacted by a process gas stream flowing through the reformer tube.

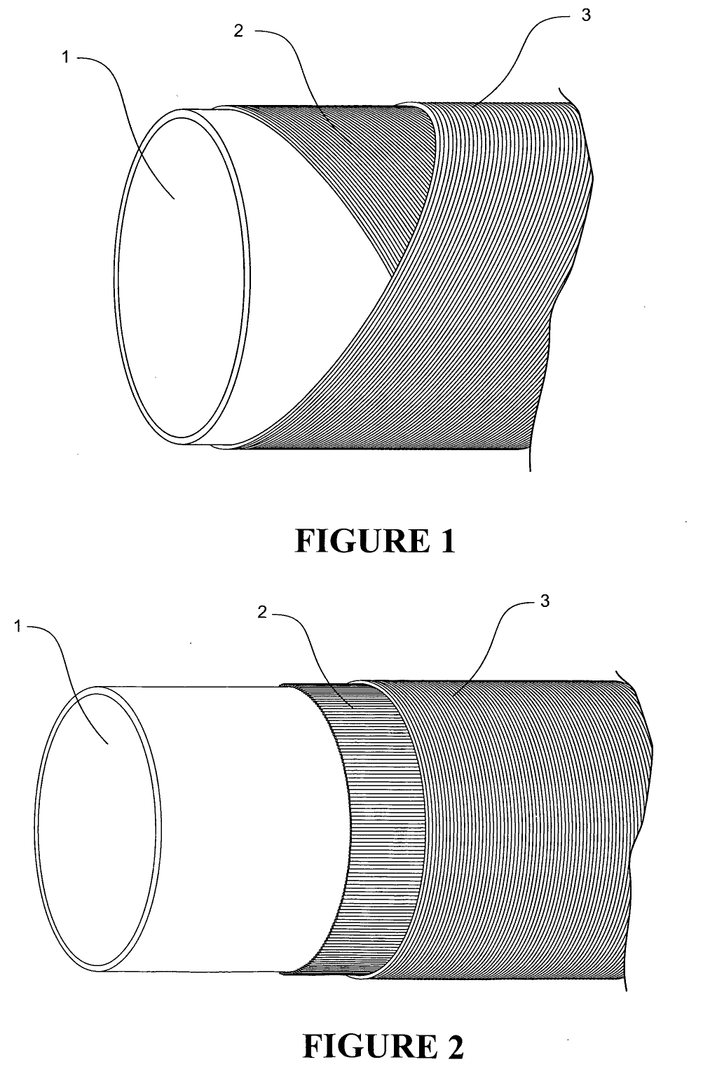

Around the exterior of the tube over at least a part of the length of the tube is a reinforcement material. In the embodiment of FIG. 1 the reinforcement material comprises a first layer 2 of a wire of a refractory metal such as tungsten, molybdenum, niobium, tantalum, or rhenium, or of alumina, which is wound at an angle to the axis of the tube as shown, and a second layer 3 which is wound at an angle to both the tube axis and the first layer, as shown. For example the first reinforcement layer 2 may be wound at an angle of approximately ±55° and the second layer 3 at an angle of approximately −55° to the tube axis. The wire may be of diameter 0.1-5 mm for example.

FIG. 2 shows a second embodiment in which the first layer 2 of filamentary reinforcement extends in the tube axis and a second layer 3 is wound transverse to the tube axis.

The reinforcement has inherently significantly higher creep resistance than the metal alloy tube, such as 20%, 50%, 100% or higher creep resistance, and possibly 2-3 orders of magnitude higher of creep resistance, at temperatures above about 40% of the absolute melting point of the metal alloy tube. The reinforcement thus assists in inhibiting downward (i.e., longitudinal or axial) creep where the tubes are vertically mounted, and in both of the embodiments described also assists in reducing diametral creep where the tubes are subject to internal pressure during plant operation. The reinforcement thus acts to prolong the effective working life of the tubes and the plant of which the tubes are a part.

In the embodiments shown there are two layers of reinforcement, in wire form. In alternative embodiments the filamentary reinforcement may be in the form of a mesh or otherwise woven refractory or alumina material. Instead of the two layers shown there may be a single layer perhaps where the tube is in use not subject to internal pressure leading to transverse creep, or there may be three or more reinforcement layers.

Tubes of the invention may be used in catalytic reformers in oil refineries, in which the tube may carry a vaporising crude oil and hydrogen mixture at a temperature up to 1000° C. and pressure up to 45 bars, or in reformers in hydrogen production, methanol production, ammonia production, or ethylene production for example, or in other industries. Tubes of the invention may be used in steamcatalytic reformers. In such applications the tubes may exhibit increased creep resistance, higher strength, and/or higher resistance to corrosion such as oxidation, at temperatures of use, relative to the equivalent un-reinforced metal alloy tube. Tubes of the invention may also be used in high temperature heat exchangers, for example in hydrogen production in jet engines, or in solar thermal energy production, for example in solar thermal high temperature collectors.

Reinforced industrial tubes of the invention may be manufactured by centrifugal casting and filament winding. Molten metal alloy may be centrifugally cast to a tube and then placed on a filament winding machine to wind one or more reinforcement layers around the tube.

Alternatively after casting the tube, a mesh or other sheet reinforcement material may be wound around the tube. Optionally a gas diffusion barrier layer may be applied to the interior of the tube by, for example, thermal spraying, or to the exterior before the reinforcement is applied to the tube.

In another form, reinforcement material is first shaped to a tubular form, for example by winding or wrapping about a mandrel, and the reinforcement tube is then placed inside a centrifugal casting mold. A metal alloy tube is then centrifugally cast against the interior of the tube of the reinforcement material. A gas diffusion barrier may then be applied to the interior of the tube.

The tubes may also be manufactured by extrusion and reinforcement winding or wrapping, in which the metal alloy tube is extruded and then placed on for example a filament winding machine where one or more layers of fibrous reinforcement material arc wound around the tube. The tubes may also be manufactured by co-extrusion, by passing the reinforcement winding or wrapping through an extrusion die as the metal alloy tube is extruded, so that the reinforcement is encased within the metal material of the tube wall. Optionally after co-extrusion a further layer or layers of reinforcement may be formed around the exterior of the tube. A gas diffusion barrier layer may be applied to the interior or exterior of the tube before or after the reinforcement material.

The filaments layers may be made up of different refractory materials, so a functionally graded composite may result.

The tubes shown in the drawings have a circular cross section but in other embodiments the tubes may have an oval or multi-segmented cross-sectional shape. While in describing the tubes, vertical mounting applications thereof have been referred to and the tubes are suitable for use in industrial plant in which the tubes extend horizontally or at an angle between the vertical and horizontal.

The reinforcement may be applied over substantially the full length of a tube such as a reformer tube or over a major part of the length of the reformer tube. Alternatively the reinforcement may be applied over a minor part of the length of the tube, at or towards one end for example and typically an end further along the tube length in the direction of gas flow through the tube in use. The number of layers of the reinforcement may also vary over the length of a tube to provide for optimum performance of the tube under operating temperature and pressure. Typically for mounting the tube the tube will have flanges or other mechanical mounts at either end thereof.

### EXPERIMENTAL

The invention is further illustrated by the following description of experimental work.

### Example 1

A 1 meter length of 42 mm-outside diameter and 6 mm wall thickness metal tube made of alloy 800H (comprising approximately 30-35 wt % Ni, 19-23 wt % Cr and small additions of aluminium and titanium with the remaining balance of iron) was reinforced with commercially available tungsten wire of 0.38 mm diameter. First, the tube was turned on a lathe to reduce the outside diameter by 1.5-mm. The reinforcing wires were wound edge-to-edge along a 700-mm section with 4 layers of windings superimposed on each other. The assembly was metal arc sprayed with approximately 1.5 mm thickness of Metallisation Wire 79E (comprising approximately 36 wt % Ni, 20 wt % Cr, 1% Mn, 2.25% Si with the remaining balance of iron) to provide oxidation protection to the tungsten wire. The final assembly was approximately 43.5 mm diameter.

For comparison, a second 1 meter length of 42 mm-outside diameter and 6 mm wall thickness metal tube made of alloy 800H was metal arc sprayed with approximately 1.5 mm thickness of Metallisation alloy 79E but did not have tungsten wire reinforcement. This tube will be referred to as the ‘Reference Tube’.

The two tube lengths were place in a furnace side-by-side and heated to 1030 C, then pressurized to 500 psig with argon. These conditions were calculated to cause failure in the Reference Tube after 1000 hours.

The Reference Tube endured 680 hours before a leak was detected. The tube of the invention endured 2720 hours under the same conditions (tested in parallel) with no leak detected, which is a 4-times improvement over actual performance of the Reference Tube. Subsequent examination revealed nil creep while the Reference Tube showed through-wall creep cracks.

### Example 2

A HP alloy tube (comprising approximately 25 wt % Cr, 35 wt % Ni, 0.4 wt % C, 39.6 wt % Fe, 1.5 wt % Mn and 1.5 wt % Si) with dimensions 1 meter length, 137 min outside diameter and inside diameter of 110 mm was reinforced with tungsten wire as in Example 1 with the following. differences: the HP alloy tube was cleaned but not reduced in diameter; the tungsten wire was 0.5 mm diameter; a final wrap of 0.9 mm alloy 625 (comprising approximately 20-23 wt % Cr, 58 wt % Ni, 0.1 wt % C, 5 wt % Fe, 3.15-4.15 wt % Co and Ta) was wound.

Test conditions were 750 psig and a temperature of 1020 C, which was calculated to cause rupture in a ordinary (unreinforced) tube made of the same tube material in 491 hours. The tube of the invention endured 1600 hours without failure and had not failed after 1600 hours, which is a 3.3-times improvement over calculated performance of an ordinary (unreinforced) tube of the same tube material.

The foregoing description of the invention includes preferred forms thereof. Modifications may be made thereto without departing from the scope of the invention as defined in the accompanying claims.

1. A tube construction for use in high temperature environments, comprising:
a tube comprising a metal alloy; and
a first reinforcement layer provided proximal to at least a portion of the tube,
wherein the first reinforcement layer comprises a filamentary material; and
wherein the filamentary material is provided edge-to-edge such that there is no gap between adjacent strands of the filamentary material.

2. The tube construction of claim 1, further comprising a second reinforcement layer provided around at least a portion of the tube and proximal to at least a portion of said first layer of reinforcement material.

3.-5. (canceled)

6. The tube construction of claim 1, wherein the filamentary material is provided in a form of a wire.

7. The tube construction of claim 6, wherein the wire is wound around at least a portion of the outside of the metal alloy tube.

8. The tube construction of claim 1, wherein the first reinforcement layer is provided within a wall of the tube.

9. The tube construction of claim 6, wherein the wire is wound around at least a portion of the tube in a direction that is substantially transverse to the longitudinal axis of the tube.

10. The tube construction of claim 6, wherein the wire is wound around at least a portion of the tube in a direction that is at an angle to the longitudinal axis of the tube.

11. (canceled)

12. The tube construction of claim 1, further comprising a second reinforcement layer provided in a form of at least one further filament, wherein the at least one further filament is wound around at least a portion of the tube proximal to the first reinforcement layer at an angle to the strands of the filamentary material of the first reinforcement layer.

13. The tube construction of claim 1, wherein the first reinforcement layer comprises a refractory metal.

14. The tube construction of claim 1, wherein the first reinforcement layer comprises at least one of alumina or tungsten carbide.

15. The tube construction of claim 12, wherein adjacent windings of the second reinforcement layer are provided edge-to-edge such that there is no gap between adjacent windings.

16. The tube construction of claim 12, further comprising a third reinforcement layer provided in a filamentary form that is wound around at least a portion of the tube, wherein windings of the third reinforcement layer are provided edge-to-edge and proximal to at least one of the first reinforcement layer or the second reinforcement layer.

17. (canceled)

18. The tube construction of claim 1, further comprising an oxidation-resistant material provided on at least a portion of an outer surface of the tube construction.

19. A method of manufacture of a tube construction for use in high temperature-environments, comprising:
providing a layer of a reinforcement material around at least a portion of a metal alloy tube,
wherein the reinforcement material has a form of a filamentary material that is provided edge-to-edge such that there is no gap between adjacent strands of the filamentary material.

20.-22. (canceled)

23. The method of claim 19, further comprising providing a second layer of reinforcement material around at least a portion of the tube proximal to at least a portion of the first layer of reinforcement material.

24. The method of claim 19, further comprising applying an oxidation-resistant material over at least a portion of the layer of reinforcement material.

25.-52. (canceled)

53. The tube construction of claim 6, wherein a diameter of the wire is between about 0.1 mm and about 5 mm.

54. The tube construction of claim 12, wherein a composition of the second reinforcement layer is different than a composition of the filamentary material of the first reinforcement layer.

55. The tube construction of claim 54, wherein the second reinforcement layer comprises Ni and Cr.

56. The tube construction of claim 18, wherein the filamentary material comprises tungsten and the oxidation-resistant material comprises Ni and Cr.
